(19) United States
(12) Patent Application Publication
(10) Pub. No.: US 2013/0287898 A1
(43) Pub. Date: Oct. 31, 2013

(54) Trivalent Chromium and Boron Fortifying Composition, a Hydration Supplement, and Process for Preparing the Same

(71) Applicants: Pradeep Poddar, Mumbai (IN); Henry Hidell, Hingham, MA (US); C.E. Agro, Oakville (CA); Micheal Collete, Oakville (CA)

(72) Inventors: Pradeep Poddar, Mumbai (IN); Henry Hidell, Hingham, MA (US); C.E. Agro, Oakville (CA); Micheal Collete, Oakville (CA)

(21) Appl. No.: 13/825,782

(22) PCT Filed: Sep. 23, 2011
(86) PCT No.: PCT/IN2011/000672

§ 371 Date: Jul. 2, 2013

(30) Foreign Application Priority Data
Sep. 23, 2010 (IN) 1068/KOL/2010

(51) Int. Cl. A23L 1/304; A23L 2/52

(52) U.S. Cl. CPC A23L 1/304; A23L 2/52
USPC 426/66; 426/648; 426/74

(57) ABSTRACT

The present invention provides nutrient fortifying composition for food products. More particularly the present invention provides chromium and boron fortifying composition comprising boron source, trivalent chromium source, copper ion source, class II preservative (202), and acidity regulator (330). The invention further provides a hydration supplement and a fortified water beverage to supplement the deficiencies of chromium and boron in humans.

### FIELD OF INVENTION

The present invention provides nutrient fortifying composition, a hydration supplement and the process for preparing the same for the improvement of health. More particularly the invention provides a Trivalent Chromium and Boron fortifying composition and its use in a hydration supplement, more particularly fortified beverages.

### BACKGROUND OF THE INVENTION

Micronutrients are nutrients needed throughout life in small quantities. They are dietary micro-nutrients needed by the human body in very small quantities (generally less than 100 micrograms/day) as opposed to macro minerals, which are required in larger quantities. The Micro minerals or trace elements include at least iron, cobalt, chromium, copper, iodine, manganese, selenium, zinc, boron and molybdenum.

Due to urbanization, over population and ill practices of agriculture there are losses of essential minerals from the soil. Due to insufficient nutrients in soil there is a declination of nutrients in food, which in turn causes deficiency of nutrients among the subjects who consume such food. Some major consequences are of such deficiencies are bone disease, in every age group.

Trivalent Chromium is an important trace element wherein the lack of sufficient Tri-Valent Chromium the diet leads to impairment of glucose utilization, however, disturbances in protein and lipid metabolism have also been observed. Impaired glucose utilization occurs in many middle-aged and elderly human beings. In experimental studies, significant numbers of such persons have shown improvement in their glucose utilization after treatment with chromium. Chromium is transported by transferring in the plasma and competes with iron for binding sites. Tri-Valent Chromium as a dietary supplement may produce benefits due to its enhancement of glucose utilization and its possible facilitating the binding of insulin to insulin receptors, which increases its effects on carbohydrate and lipid metabolism. Tri-Valent Chromium as a supplement may produce benefits in atherosclerosis, diabetes, rheumatism, and weight control.

Boron is required by the body in trace amounts for proper metabolism of calcium, magnesium, and phosphorus. Boron helps brain function, healthy bones, and can increase alertness. Boron is also useful for people who want to build muscle. Boron is known to help prevent postmenopausal osteoporosis. Further, a relationship has been shown between a lack of boron in the diet and the chances of developing arthritis.

Since the acute shortage of the nutrients particularly Tri-Valent Chromium and Boron causes major health issues among humans such as diabetes, deficiencies in bones, etc., it has been very important to supplement the same through food. To overcome these health problems fortifications have been introduced in the masses so as to provide them nutrition. Trivalent Chromium is very important to regulate insulin and thus controlling diabetes. So, a modest amount of Tri-Valent Chromium sourced from chromium 454 needs to be fortified in the drinking water for the population. Similarly Boron not only enhances calcium but also helps in magnesium uptake. The population such as old people age more than 60 years and women who are pre or post-menopausal are in great need of this mineral.

However, supplementing the micro nutrient deficiencies through food is not always feasible due to different food habits of the subjects in different geographical locations. However, the same can be done through drinking water.

Therefore, the object of the present invention is to provide a composition of micronutrients for fortifying food for human consumption.

Further, the object of the present invention is to provide a micro nutrient composition comprising Tri-Valent Chromium and Boron for fortifying food for human consumption.

Further, the object of the present invention is to provide a hydration supplement fortified with the micro nutrients to supplement the deficiencies in humans.

Further, the object of the present invention is to provide treated water fortified with the micro nutrients to supplement the deficiencies.

Yet another object of the present invention is to provide treated water fortified with boron and Tri-Valent Chromium to reduce the deficiencies diseases in humans.

Further, object of the present invention is to provide the process for the preparation of the composition of micronutrients.

Further, object of the present invention is to provide the process for the preparation of the treated water beverage fortified with the micro nutrients to supplement the deficiencies.

### SUMMARY OF THE INVENTION

In order to obviate the drawbacks of the prior art and to provide supplement of the micro-nutrients, the present invention provides a composition of micronutrients particularly Tri-Valent Chromium and Boron for fortifying food for human consumption

Thus, the present invention provides Tri-Valent Chromium and Boron health composition for fortifying food products. Said composition comprises:
boron source,
trivalent chromium source,
copper ion source,
class II preservative (202), and
acidity regulator (330)

The amount of the ingredients in the composition is as follows:
boron source about 44.2% to 45.5% by weight
trivalent chromium source about 0.17% to 0.20% by weight
Copper Ion Source about 32 to 35% by weight
class II preservative (202) about 15.5% to 16.5% by weight
acidity regulator (330) about 3.95% to 4.15% by weight

The invention further provides a hydration supplement for human consumption. Said hydration supplement comprising the—Health composition along with a suitable food item. The amount of composition in the hydration supplement is about 0.006% by weight such that the amount of the Tri-Valent Chromium source in the composition is 0.0000105% to 0.000012% by weight and amount of Boron source in the composition is 0.0025% to 0.0028% by weight. The amount of copper in the composition is about 0.00215% by weight.

Said a hydration supplement is in liquid or semi solid form. Further said snack may be a beverage such as aerated drink, treated water, etc.

The invention further provides treated water fortified with Tri-Valent Chromium and boron for use as beverages. Said fortified water comprises:
treated water,
Health composition comprising trivalent chromium sourceboron source, Copper Ion Source, class II preservative (202), acidity regulator (330), and Chromium 454™

The amount added is equivalent to 10 ppb & 675 ppb of elemental Tri-Valent Chromium & boron to fortify treated water beverage, sourced from Chromium 454™ and FruiteX-B® calcium fructorbate respectively.

The water-neutral beverage of the present invention provides the essential micro-nutrients boron (0.675 mg per litre), trivalent chromium (0.011 mg per litre), and copper (1 mg per litre) from the proprietary custom “Health Composition”.

Further the water of present invention has no added flavors or sweeteners to mask ingredient flavors.

The ingredients used in the water neutral beverage are selected in a manner as to be compatible with water such that they do not have any odour, the composition does not precipitate or reacts or sediments. Also, the shelf life of the elements has been so maintained in the composition that when the composition does not degrade when used with water. Said effects are the result of the synergistic effect among the ingredients of the composition.

Tri-Valent Chromium and Boron together have a synergistic relationship in human blood sugar metabolism by helping to prevent both diabetes and type 2 diabetes.

Further, Since Trivalent Chromium supports insulin metabolism and Boron promotes bone heath, these have a synergistic relationship to help promote consumers to be ‘Active’

Further, the Copper from the Copper source in the composition enables cold-filling process of packaging. The filling could then be carried out without the presence of ozone in the product and also obviating the necessity of hot-fill process thereby enhancing the bio-availability of the Tri-valent Chromium & the Boron from the composition.

The invention further provides the process of preparation of the blend comprising the admixing of the ingredients.

The invention further provides the process for the preparation of the treated water fortified with Tri-Valent Chromium and boron.

Said process comprises treatment of source water, adding proprietary Health composition in a suitable manner to get the fortified Water beverage ready to fill and pack as required. The process has been designed to meet the specific requirements of the beverage of the present invention.

This process further involves effective treatment and sterilization of water without having to use chemicals or long storage or heat. This on line treatment reduces the risks of the water and also provides a consistent base characteristic on which the composition can enhance to achieve the desired nutritional characteristics

### DETAILED DESCRIPTION OF THE INVENTION

The deficiency of the micro nutrients causes various diseases. Thus, in order to prevent them, present invention provides an inexpensive source and additional dietary nutrients such as Tri-Valent Chromium & boron in water for the populations in need. The data providing a support to the conclusion that these are the essential micro minerals that are often in short supply due to various reasons in the human populations worldwide. And that fortified water providing a small increment in the amount of Tri-Valent Chromium & boron daily intake is safe and very likely to provide a health benefit.

Tri-Valent Chromium is an essential biologically active element, and a part of Oligopeptide-chromodulin-potentiating insulin.
Binding of Cr (III) with nucleic acids has been found to stimulate the DNA-dependant RNA synthesis.
The trivalent form of chromium is most stable and essential for human body.
It also acts as a co-factor in insulin, the biologically active form of the element is believed to be a nicotinic acid—amino acid (glycine, glutamic acid, and cysteine)—trivalent chromium complex, which functions as a potentiator of insulin.
It is an active component of glucose tolerance factor (GTF) and has beneficial effect on blood regulation mechanisms.
Required for normal sugar and fat metabolism. It also helps in protein metabolism.

Food and Nutrition Board, Institute of Medicine, National Acedemies, US, has established the adequate intakes of chromium for different age group in the year 2001. Through that summary, the dietary reference intake (DRI) for chromium is given in table 1 below:

TABLE 1
Dietary Reference Intakes for chromium in human
as per given by FNB, IOM in the year 2001.

Chromium, μg/day

| Life stage | Male | Female |
|---|---|---|
| Infants, months | | |
| 0-6 | 0.2 | 0.2 |
| 7-12 | 5.5 | 5.5 |
| Children, years | | |
| 1-3 | 11 | 11 |
| 4-8 | 15 | 15 |
| Adults, years | | |
| 9-13 | 25 | 21 |
| 14-18 | 35 | 24 |
| 19-30 | 35 | 25 |
| 31-50 | 35 | 25 |
| 51-70 | 30 | 20 |
| >70 | 30 | 20 |
| Pregnancy, years | | |
| <18 | — | 29 |
| 19-30 | — | 30 |
| 31-50 | — | 30 |

The U.S. Food and Nutrition Board has set an adequate and safe range for chromium intake at 0.05 to 0.2 mg/day.

The health effects resulting from exposure to Cr (III) & Cr (VI) from literature reveals that Cr (VI) is toxic for human and Cr (III) is nutritionally essential.

Several constituents occurring naturally in the food have been found to affect the absorption of chromium from the intestine and increase or decrease its bioavailability apart from a low or excess intake of dietary Chromium, which appears to increase or decrease the efficiency of Chromium absorption in the body. It has an effect on carbohydrate, lipids, proteins, nucleic acids and some of the minerals. A decreased loss of some micronutrients such as Zinc, Iron, Copper and Manganese were observed during stress after Chromium supplementation to mice. Studies on the interaction between Chromium, Calcium and Magnesium showed that increase in Chromium supplementation happened when there is a decrease in Magnesium and Calcium concentration. Chromium also effects certain hormones like insulin.

### Dietary Sources of Chromium

Tri-Valent Chromium is found in different foods including both plants and animals, but the important dietary sources of Tri-Valent Chromium are whole grains, mussel, brazil nut, oyster, dates (dried), pear, potatoes, oysters, liver, seafood, spices, cheese, chicken, meat etc, whereas brewer's yeast is a rich source of organic Tri-Valent Chromium complexes. [Source:—dietary supplement fact sheet: chromium]

### Interest in Chromium Fortified Products

Along with the current developments of the overall functional food markets, the use of minerals especially chromium salts is expected to exhibit strong growth rates. Future trends include growing consumer concern regarding diabetes, leading to increased sales of chromium salts.

### Chromium 454

Substances that are water-soluble often are more easily absorbed during transport through the gastric system. Chromium 454 dissolves well in water at room temperature and exhibits a signature purple-violet color in solution. Because of increased solubility, Chromium 454 offers potential formulation advantages not enjoyed by other forms of chromium.

Chromium 454 is a patented organic compound, which is water-soluble trivalent chromium with highly bioavailablity. The Chromium (III) is covalently bonded to food derived bioorganic molecules of all natural water soluble, proprietary extracts of the cytoplasm of brewer's yeast. Since in Chromium 454, only low molecular weight nucleotides and nucleoside are bound as ligands, there is no allergic challenge and the resultant low molecular weight bound chromium is highly bioavailable. The organic molecule of trivalent chromium has molecular weight less than 1000, which accounts for its water solubility and bioavailability.

### Function of Boron in Human Body

As an ultra trace element, boron is necessary for the optimal health of rats and presumably other mammals, though its physiological role in human is rarely understood. Only organo-boron compounds are apparently important in biological systems during normal physiological conditions. Based on various studies conducted worldwide, we can say that boron is an essential mineral for humans and animals to:
Affects blood biochemical markers of energy and mineral metabolism such as calcium and magnesium.
Especially boron seems to be important for energy utilization and the development and maintenance of bone. It helps bones to take up calcium.
It helps in many of the diseases commonly found in postmenopausal women, including osteoporosis, cardiovascular disease, brain function cancer, and non-insulin-dependent diabetes mellitus (type 2 diabetes).
It cures arthritis and musculoskeletal disorders.

### How Much Boron do we Need?

Boron is safe if taken in range of 3-9 mg per day recommended for adult human. Table 2 is providing the tolerable upper limits values of boron age wise.

TABLE 2
The Dietary Reference Intake of Boron age wise

Boron, mg/day

| Life stage | Male | Female |
|---|---|---|
| Infants (months) | | |
| 0-6 | — | — |
| 7-12 | — | — |
| Children (years) | | |
| 1-3 | 3 | 3 |
| 4-8 | 6 | 6 |
| Adults (years) | | |
| 9-13 | 11 | 11 |
| 14-18 | 17 | 17 |
| 19-30 | 20 | 20 |
| 31-50 | 20 | 20 |
| 51-70 | 20 | 20 |
| >70 | 20 | 20 |
| Pregnancy (years) | | |
| <18 | — | 17 |
| 19-30 | — | 20 |
| 31-50 | — | 20 |

Humans given 100 mg of boron intravenously 40 or 270 mg of boric acid orally reported no discomfort and showed no obvious signs of toxicity. But sometimes, the boron taken 100 mg or above, may be toxic.

Several constituents occurring naturally in the food have been found to affect the bioavailability of boron such as vitamin D, certain hormones and some of the minerals. Boron supplementation markedly reduced the urinary excretion of calcium and magnesium, increases serum levels of both copper and copper-dependent enzymes and lowers the serum phosphorus concentrations in female. Several human experiments conducted by Nielsen and colleagues have shown that dietary boron manipulation may affect blood composition, copper, thyroid hormone, estrogen, testosterone, and most notably, calcium metabolism.

When swallowed and inhaled, boron is widely distributed throughout the body, and the bones take some of it. It is then rapidly excreted; about 90% through urine, with boron incorporated in bone taking a longer time to be eliminated. Boron is well absorbed from the gastrointestinal tract in humans, once ingested through food borates are almost completely absorbed in the gut and appear rapidly in the blood and body tissues.

### Dietary Sources of Boron

Within the diet, the richest sources of boron are fruits such as pears, prunes, apples, vegetables such as tomatoes, carrots, pulses, legumes, and nuts & dry fruits such as almond, raisins etc. Dairy products, fish, meats and most grains contain very little boron.

### Interest in Boron Fortified Products

The amounts of ingredients fortified in the water are nutritionally important and would represent a meaningful increase in usual intakes of boron. Regular consumption of this water, which is being fortified with FruitexB Calcium Fructoborate, would lead to a healthier life. This product is very beneficial for the population, who is suffering from bone deformities, menopause symptoms.

### FruiteX-B

FruiteX-B is the world's only food form source of the trace element of boron. FruiteX-B is a white, slightly sweet, odorless, water-soluble powder that can be used in supplements, bars and beverages. It is chemically known as Calcium Fructoborate Ca(C₆H₁₀O₆BO)₂X₃X₅H₂O and is a unique boron-calcium carbohydrate molecule found in apricots, raisins, almonds, hazelnuts, avocados, fruits, nuts, legumes and vegetables.

FruiteX-B is a fruit mineral complex, which provides an effective way to support healthy bones and joints. FruiteX-B may help increase blood levels of vitamin D in individuals suffering from deficiency. It optimizes calcium, magnesium and phosphorus metabolism and improves mental functions such as eye-hand coordination, attention, perception and memory.

Boron-carbohydrate complexes are preferentially constructed with fructose into Beta-Fructo-Furanoside-Borate; Alpha-Fructo-Furanoside-Borate and Alpha-Fructo-Pyronosido-Borate. In contrast boron does not complex with amino acids or hydroxy acids in the world of plants. Therefore, the most natural boron complexes that would in turn be most compatible with human chemistry are the fructo-borates from plants. They may be expected to be properly active and selectively utilized in biological systems.

Bioavailability of Boron as FruiteX-B: The relative systemic availability of boron from oral FruiteX-B for 43 microgram and 1000 microgram amounts of boron were 110 and 160% when compared to the equivalent amounts of boron citrate. These results show that more actual boron is assimilated from FruiteX-B.

### Functions of Copper in Human Body

Copper plays a significant role in human physiology. Copper is utilized by most cells as a component of enzymes (cuproenzymes) essential for many biochemical functions to occur normally in human body. Copper is a major component of catalytic center with Zinc superoxide dismutase in different redox reactions in the enzymes and thus its presence is important for normal physiological functions.

Functions of cuproenzymes with oxidation-reduction activity and copper binding proteins in human are given in table 3.

TABLE 3
Function of cuproenzymes in oxidation
and reduction activity of human

| Cuproenzymes | Important functions |
|---|---|
| Amino acid oxidase | Amino acid metabolism i.e. |
| | Deamination of primary amines |
| Ceruloplasmin | Copper transport, conversion of iron |
| | into active form for transportation |
| | to various tissues. |
| Cytochrome-C oxidase | Energy production |
| Catechol oxidase | Synthesis of melanin |
| Dopamine-β monooxygenase | Noradrenaline synthesis |
| Protein-lysine 6-oxidase | Collagen and elastin cross-linking |
| Peptidylglycine monooxygenase | α-Amidation of neuropeptides |
| Superoxide dismutase | Protection of cell from free redical |
| | damage |
| Superoxide dismutase & lysyl | Strengthens connective tissues |
| oxidase | |
| Metallothionein | Radical scavenging, Metal transport |

Thus, vital role played by copper in the human body includes the following.
1. Formation of strong, flexible connective tissue and helps in the proper cross linking of collagen and elastin. Elastin helps to promote normal cardiovascular functions.
2. Production of collagen—the protein responsible for the structural formation of bone, cartilage, skin & tendon: prevents bone problems such as arthritis, osteoporosis, and rheumatoid arthritis.
3. Inhibition of free radical formation.
4. Formation of adenosine triphosphate (ATP) the fuel to run the body.
5. Production of hemoglobin thus helping to prevent anemia.
6. Promotes the maintenance of good skin health and contributes to healthy respiration and general strength.
7. Contributes to healthy and normal cholesterol levels.
8. Excellent for immune system.

### How Much Copper do we Need?

The average adult human body generally contains 50-80 mg of copper. Recommended dietary allowance (RDA) for copper is shown in Table 4 as per The Food and Nutrition Board, Institute of Medicine, National Academies.

TABLE 4
Recommended dietary allowance (RDA) of copper for human

Copper, μg/day

| Life stage | Male | Female |
|---|---|---|
| Infants | | |
| 0-6 months | 200* | 200* |
| 7-12 months | 220* | 220* |
| Children | | |
| 1-3 years | 340 | 340 |
| 4-8 years | 440 | 440 |
| 9-13 years | 700 | 700 |
| 14-18 years | 890 | 890 |
| Adults | | |
| 19-30 years | 900 | 900 |
| 31-50 years | 900 | 900 |
| 51-70 years | 900 | 900 |
| >70 years | 900 | 900 |
| Pregnancy | | |
| 14-18 years | — | 1000 |
| 19-30 years | — | 1000 |
| 31-50 years | — | 1000 |
| Lactating | | |
| 14-18 years | — | 1300 |
| 19-30 years | — | 1300 |
| 31-50 years | — | 1300 |

*is the Adequate Intakes and the rest are the Recommended Dietary Intakes as per given by FNB

Copper can be quite toxic when introduced into a living system in amounts that exceed the system's ability to render the metal safe through binding proteins or other means. Infants fed with cow milk based diets exclusively are more prone to develop copper deficiency than infants who are breast fed because of the low copper content of cow milk and limited absorption of this mineral in cow milk. While the milk stored and boiled in the copper utensils is sometimes toxic and in India this decline in copper found when copper vessels are avoided for these kind of uses.

### Dietary Sources of Copper

Copper is found in number of food items, originating from both plants as well as animals. The plants or the plant parts normally rich in copper are nuts, seeds, whole grains, legumes, chocolates, cherries, dried nuts, root vegetables, cereals, peas, beans, tomatoes, milk, tea, potatoes while the food originating from animal source rich in copper are such as organ meat, chicken, seafood etc. Drinking water delivered through copper plumbing is a minor source of copper. It has long been established since the ancient times and the times of Ayurveda that drinking water when kept and taken from copper vessels is a cure for several ailments. For the same reason copper pipes were used for plumbing for delivering drinking water in many Middle East countries.

### Interest in Copper Fortified Product

Deficiency of copper causes
[symbol] Anemia
[symbol] Nutropenia
[symbol] Bone abnormalities in low birth weight in infants & in young children; fractures, osteoporosis, epiphyscal separation, fraying and cupping of metaphyses with spur formation and subperiostal new bone formation.

### Copper Ion Source

Copper in the cupric (Cu²⁺) state is believed to be readily absorbable and efficiently transported across cellular membranes. The ions also provide a unique product stabilizing residual anti microbial efficacy for beverages that retards the growth of bacteria & other microorganisms including Salmonella, Fungi, Coliforms, Vibriocholera. This unique efficacy is residual and occurs during the growth of the microorganisms.

The amount of copper proposed for this product is modest 0.1 mg per 100 ml of water. The proposed copper for source is treated Copper Sulphate, an ingredient with appropriate bioavailability, solubility and neutral taste.

Therefore, in order to prevent and bring down the occurrence of its deficiency diseases, it is necessary to supplement the daily food by providing additional quantities of the nutrients and this can be best done by way of fortification of a product of major consumption.

The present invention provides supplement for the micro-nutrients particularly tri-valent chromium and boron. The invention provides Health composition of micronutrients for fortifying water. Said Health composition comprises:
FruiteX-B® calcium fructorbate,
Copper Ion Source,
Chromium 454™,
class II preservative (202), and
acidity regulator (330)

The amount of the ingredients in the composition is as follows:
FruiteX-B® calcium fructorbate about 44.2% to 45.5% by weight
Chromium 454™ about 0.17% to 0.20% by weight
Copper Ion source about 32% to 35% by weight
class II preservative (202) about 15.5% to 16.5% by weight
acidity regulator (330) about 3.95% to 4.15% by weight

The composition of the present invention can be used as nutrient supplement in food items such as beverages, snacks, powered milk, etc. depending upon the nutrient requirement the composition of the present invention can be added in the food items.

In another embodiment present invention provides a hydration supplement for human consumption. Said hydration supplement comprising the Health composition along with a suitable beverage. The amount of composition to be added in the hydration supplement is about 0.006% by weight such that the amount of the tri-valent chromium source in the composition is 0.17% to 0.20% or about 0.105 mg per liter and amount of Boron source in the composition is about 44.2% to 45.5% or about 27.5 mg per liter. The amount of copper source in the composition is about 32% to 35% or 21.5 mg per liter

Said a hydration supplement is in liquid or semi/solid form. Further said hydration supplement may be a beverage such as aerated drink, treated water, etc.

In yet another embodiment of the present invention is provided a water based hydration supplement or beverage comprising treated water fortified with tri-valent chromium and boron. Said fortified water comprises:
treated water prepared by the process of our co-pending patent application no. 1069.KOL/2010,
Health composition comprising FruiteX-B® calcium fructorbate, Copper Ion source, class II preservative (202), acidity regulator (330), and Chromium 454™.

The amount added is equivalent to 10 ppb & 675 ppb of elemental Tri-Valent Chromium & boron in water, from chromium 454™ and FruiteX-B® calcium fructorbate respectively.

The above water based beverage of the present invention provides the water-neutral beverage with the essential micro-nutrients including boron (0.630 mg to 0.675 mg per litre), trivalent chromium (7.5 mcg to 10 mcg per litre), and copper (0.8 mg to 1 mg per litre) from the proprietary custom Health composition.

Said beverage contains water with no flavors or sweeteners to mask ingredient flavors.

The ingredients used in the water neutral beverage are selected in a manner as to be compatible with water such that they do not have any odour, the composition does not precipitate or reacts or sediments. Also, the shelf life of the elements has been so maintained in the composition that when the composition does not degrade when used with water. Said effects are the result of the synergistic effect among the ingredients of the composition.

Tri-Valent Chromium and Boron together have a synergistic relationship in human blood sugar metabolism by helping to prevent both diabetes and type 2 diabetes

Calcium Fructoborate used in the present invention not only provides the boron micronutrient but also a value of calcium to benefit from the more bioavailability through the boron relationship. This is the synergy between the boron as a micronutrient and the calcium present in the calcium fructoborate.

The trace element of Chromium 454 is more associated with glucose metabolism. The Chromium 454 assists in the transfer of energy from the glucose source to the muscle tissue which overall result in a high level of physical strength through sustaining muscle energy. Muscle strength thereby supports the skeletal structure which is experiencing higher values of calcium through the presence of boron in the body leading to general healthier conditions.

For this reason, the fundamental synergy occurs as one rebuilds skeletal structure and reduces joint inflammation, in the presence of the Chromium 454 which will assist in the transfer of energy. The final analysis is energy to the muscle which then allows for a more active person and with a stronger skeleton.

Synergy is measured in many benefits of all of the proposed products. By addressing bone health one must address other components of health which turns the fundamental component of bone health into a functional overall health such as energy transfer to muscles which in return, builds muscle strength through more energy to support more physical activity leading to a more productive life. It is difficult to isolate each micronutrient when in combination, the product line when consumed will lead to the goal of healthier and more productive lives

Thus the combination of the micronutrients complements each other while permitting a water neutral product to result.

The table 5 shows the amounts of nutrients per liter of water

TABLE 5

| Ingredients | (in 1 liter) | | Active Ingredients per liter |
|---|---|---|---|
| FruiteX B ® | 27.5 mg | Delivers | 27.5 mg of Fructoborate |
| Calcium | | | providing 0.675 mg of Boron |
| Fructoborate | | | |
| Chromium 454 ® | 0.105 mg | Delivers | 10 mcg of Trivalent Chromium |
| Copper Ion | 21.5 mg | Delivers | 1 mg of Cu |
| Source | | | |

TABLE 6

| | Quantity | | % of | Safe | | Upper level | Median | |
|---|---|---|---|---|---|---|---|---|
| | (per | RDA - | RDA in | Upper level | | of Tolerable | Intake - | |
| | liter) | India | one liter | per day | Source | Intake - US | US adults | Validation |
| Boron | 0.675 mg | NA | No RDA in | 9.6 mg | Expert group of | 20 mg | 0.87-1.35 | US Data provided by |
| | | | CODEX, | | vitamins & | | | Annette Dickinson, (Note |
| | | | WHO or | | Minerals, UK - | | | encl) |
| | | | ICMR | | 2003(Article encl). | | | |
| Chromium | 10 mcg | 50 mcg | 15% | 10 mg | Expert group of | In line with | NA | Excellent safety data with |
| | | | | | vitamins & | UK. No Upper | | evidence of toxicity. |
| | | | | | Minerals, UK - | level | | Supplementation can go |
| | | | | | 2003(Article encl) | | | upto 200 mcg as body |
| | | | | | | | | tends to have homeostatic |
| | | | | | | | | response in controlling Cr |
| | | | | | | | | Levels - John Hunter & |
| | | | | | | | | Annette Dickinson. |
| Copper | 1 mg | 2 mg | 50% * | 10 mg | Expert group of | 10 mg | NA | US Data provided by |
| | | | | | vitamins & | | | Annette Dickinson, (Note |
| | | | | | Minerals, UK - | | | encl) |
| | | | | | 2003(Article encl) | | | |

* exceeds the unstated upper limit of 33% of RDA for ‘non supervised’ fortification as per PFA ( Re Dr. Seshikeran). Study reports on Copper toxicity and storage in human systems have established a safe upper limit of 10 mg/day in a 60 kg

The water based beverage of the present invention has been found to have been beneficial in restoring the health of the humans having deficiencies of Tri-Valent Chromium and boron.

The invention further provides the process for the preparation of the treated water fortified with Tri-Valent Chromium and boron. Said process comprises the steps of:
treated water prepared by the process as disclosed in our co-pending application,
adding proprietary composition in a suitable manner to get the beverage ready to fill and pack as required.

The process has been designed to meet the specific requirements of the beverage of the present invention.

This process further involves effective treatment and sterilization of water without having to use chemicals or long storage or heat. This treatment of source water involves filtration, ozonization, deozonization before filtration through reverse osmosis. The permeate is UV sterilized and then used as a solvent for the composition. This on line treatment reduces the risks of the water and also provides a consistent base characteristic on which the composition can enhance to achieve the desired nutritional characteristics. The composition beverage is filled and packed as required.

The invention will now be explained with the help of following examples. However, the scope of the invention should not be limited to these examples as the person skilled in the art can easily vary the proportion of the ingredients and combinations.

### Example 1

Preparation of the Tri-Valent Chromium and boron fortifying composition for health Two different packages (one dry parts & one Liquid part) is prepared for the batch of 25000 liters.

### 1.002625 kg of Dry Part 1 Comprises:

0.6875 kg of Calcium Fructoborate
0.003479 kg of Chromium 454
0.25 kg of Potassium Sorbate
0.0625 kg of Citric Acid.

These ingredients are carefully weighed, blended and packaged in a sterile & dry container for use at the manufacturing facility. The specification sheets are maintained and the dry part 1 has to meet the specifications at the manufacturing location before these are used for the preparation of the concentrate.

### 0.5375 of Liquid Part Comprises:

### 0.5375 kg of Nutribond Copper Sulphate

The ingredient is carefully weighed and packaged in a sterile & dry container for use at the manufacturing facility. The specification sheets are maintained and the liquid part has to meet the specifications at the manufacturing location before these are used for the preparation of the concentrate.

### Example 2

### Preparation of the Tri-Valent Chromium and Boron Fortified Water Beverage with Fortifying Composition for Health

A blending tank of 225 liters is taken for making the concentrate. 200 liters of treated water is made available in the blending tank. The dry part is added to this water. The stirring operations are carried out for 15 mins. The liquid part is added while the stirring is maintained. Treated Water is then added to make the volume of concentrate in the tank to 225 liters. Dosing operation is then carried out to make the fortified Trivalent Chromium & Boron product.

1. A tri-valent chromium and boron fortifying health composition for health comprising:
boron source;
trivalent chromium source;
copper ion source;
class II preservative (202); and
Acidity regulator (330)
wherein
boron source is in an amount of about 44.2% to 45.5% by weight;
trivalent chromium source is in an amount of about 0.17% to 0.20% by weight;
copper ion source is in an amount of about 32 to 35% by weight;
class II preservative (202) is in an amount of about 15.5% to 16.5% by weight; and
Acidity regulator (330) is in an amount of about 3.95% to 4.15% by weight.

2. The trivalent chromium & boron fortifying health composition as claimed in claim 1, wherein the ratio of the elemental chromium to the elemental Copper is maintained at 1:100.

3. The trivalent chromium & boron fortifying health composition as claimed in claim 1, wherein the ratio of the elemental Boron to the elemental Copper is 67.5:1.

4. The trivalent chromium & boron fortifying health composition as claimed in claim 1, wherein trivalent chromium source is Chromium 454.

5. The trivalent chromium & boron fortifying health composition as claimed in claim 1, wherein boron source is calcium fructoborate.

6. The trivalent chromium & boron fortifying health composition as claimed in claim 1, wherein the copper ion source is copper sulphate.

7. The trivalent chromium & boron fortifying health composition as claimed in claim 1, wherein the class II preservative (202) is potassium sorbate.

8. The trivalent chromium & boron fortifying health composition as claimed in claim 1, wherein the acidity regulator is citric acid.

9. The trivalent chromium & boron fortifying health composition as claimed in claim 5, wherein the calcium fructoborate is present in an amount of 44.64% or 27.5 mg per liter.

10. The trivalent chromium & boron fortifying health composition as claimed in claim 4, wherein the Chromium 454™ is present in an amount of 0.17% or 0.105 mg per liter.

11. The trivalent chromium & boron fortifying health composition as claimed in claim 1, wherein the Copper Ion Source is present in an amount of 34.9% or 21.5 mg per liter.

12. The trivalent chromium & boron fortifying health composition as claimed in claim 1, wherein the class II preservative (202) is present in an amount of 16.23% or 10 mg per liter.

13. The trivalent chromium & boron fortifying health composition as claimed in claim 1, wherein the acidity regulator (330) is present in an amount of 4.06% or 2.5 mg per liter.

14. A hydration supplement comprising a tri-valent chromium and boron fortifying composition comprising:
boron source;
trivalent chromium source;
copper ion source;
class II preservative (202); and
Acidity regulator (330)
wherein
boron source is in an amount of about 44.2% to 45.5% by weight;
trivalent chromium source is in an amount of about 0.17% to 0.20% by weight;
copper ion source is in an amount of about 32 to 35% by weight;
class II preservative (202) is in an amount of about 15.5% to 16.5% by weight; and
Acidity regulator (330) is in an amount of about 3.95% to 4.15% by weight;
wherein the tri-valent chromium and boron fortifying composition is present in an amount of about 0.0006% by weight such that the amount of tri-valent chromium source in the composition is 0.17% to 0.20% by weight and amount of boron source in the composition is about 44.2% to 45.5% by weight, wherein the amount of copper source in the tri-valent chromium and boron fortifying composition is about 32% to 35% by weight.

15. The hydration supplement as claimed in claim 14, wherein said supplement is liquid or semi solid selected from the group comprising of aerated drinks, treated water, juices, etc.

16. A water beverage, comprising treated water and fortifying tri-valent chromium and boron composition comprising:
boron source;
trivalent chromium source;
copper ion source;
class II preservative (202); and
Acidity regulator (330)
wherein
boron source is in an amount of about 44.2% to 45.5% by weight;
trivalent chromium source is in an amount of about 0.17% to 0.20% by weight;
copper ion source is in an amount of about 32 to 35% by weight;
class II preservative (202) is in an amount of about 15.5% to 16.5% by weight; and
Acidity regulator (330) is in an amount of about 3.95% to 4.15% by weight;
wherein, said water beverage comprises about 0.063 to 0.675 mg/litre boron, about 0.007 to 0.011 mg/litre tri-valent chromium and about 0.8 to 1 mg/litre copper.

17. The water beverage as claimed in claim 16, wherein said water beverage comprises chromium in an amount of about 0.7 to about 1.2 mcg/100 ml.

18. The water beverage as claimed in claim 16, wherein said water beverage comprises boron in an amount of about 63 to about 97 mcg/100 ml.

19. The water beverage as claimed in claim 16, wherein said water beverage comprises copper in an amount of about 0.08 to about 0.12 mg/100 ml.

20. The water beverage as claimed in claim 16, wherein said water beverage is neutral, colourless, odourless and requires no added flavor or sweeteners to mask ingredients.

21. A process of preparing the water beverage fortified with tri-valent chromium and boron fortifying composition for health comprising the steps of:
effective treatment and sterilization of source water;
fortifying said treated water with the tri-valent chromium and boron fortifying composition.
